(19) United States
(12) Patent Application Publication
(10) Pub. No.: US 2026/0115735 A1
(43) Pub. Date: Apr. 30, 2026

(54) HIGH-GRADIENT MAGNETIC FIELD FOR SUSTAINABLE TRANSITION METAL SEPARATION AND RECOVERY

(71) Applicant: FLORIDA STATE UNIVERSITY RESEARCH FOUNDATION, INC., Tallahassee, FL (US)

(72) Inventors: Hadi Mohammadigoushki, Tallahassee, FL (US); Munir Humayun, Tallahassee, FL (US); Theo Siegrist, Tallahassee, FL (US)

(21) Appl. No.: 19/374,708

(22) Filed: Oct. 30, 2025

Related U.S. Application Data
(60) Provisional application No. 63/713,917, filed on Oct. 30, 2024.

(51) Int. Cl. B03C 1/033; B01D 35/06; B01D 35/26; B01D 39/12; B03C 1/00; B03C 1/30; H01M 10/54

(52) U.S. Cl. CPC B03C 1/0335; B01D 35/06; B01D 35/26; B01D 39/12; B03C 1/002; B03C 1/30; B03C 2201/18; H01M 10/54

(57) ABSTRACT

Systems and methods are provided for the transport and separation of transition metal solutes using magnetic fields. A high-gradient magnetic field can be generated between the flat-faced poles of an electromagnet. The magnetic separation process can be enhanced by the aggregation of paramagnetic metal solutes into clusters, which are predicted to be two orders of magnitude larger than individual solute units.

### CROSS-REFERENCE TO RELATED APPLICATION

This application claims the benefit of U.S. Provisional Application Ser. No. 63/713,917, filed Oct. 30, 2024, the disclosure of which is hereby incorporated by reference in its entirety, including all figures, tables, and drawings.

### BACKGROUND

Following the discovery of Faraday on electromagnetism, magnetic separation has long been used as a technique to separate components of a mixture based on their magnetic properties [1]. This method has found applications in a wide range of processes, from the nuclear industry, drug delivery, chemical kinetics, chemical separation, mining, water purification, the biochemical and medical fields [2-7]. As the global economy shifts toward sustainable and renewable energy sources, lithium-ion batteries (LIBs) are increasingly used in nearly every electronic product. With the ever-growing need for LIB production, many millions of tons of LIBs will reach their end of life in the near future and, if not properly recycled, could potentially lead to a detrimental impact on natural resources, the supply chain, the environment, and energy conservation. In addition to LIBs, a wide range of electronic equipment contain critical metals such as lithium, nickel, cobalt, and manganese, and a key challenge in their recycling is the effective separation of these metal solutes from mixed solutions. Current separation methods for these metals are costly, energy intensive, and cause significant environmental pollution [8-10].

### BRIEF SUMMARY

In view of the challenges discussed in the Background section, there is a pressing need for greener and more environmentally friendly separation techniques. The critical metals found in spent lithium-ion batteries (LIBs) and other electronic equipment display a wide range of magnetic susceptibilities, with some being paramagnetic and others diamagnetic. Magnetic separation presents an environmentally sustainable option by reducing waste, improving recycling efficiency, minimizing pollution, and conserving energy. These advantages make it a promising alternative for recycling critical metals from end-of-life LIBs and other waste streams. Embodiments of the subject invention provide novel and advantageous systems and methods for the transport and separation of transition metal solutes using magnetic fields. A high-gradient magnetic field (or in some cases, a homogeneous magnetic field) can be generated between the flat-faced poles of an electromagnet. The magnetic separation process can be enhanced by the aggregation of paramagnetic metal solutes into clusters, which are predicted to be two orders of magnitude larger than individual solute units.

In an embodiment, a method for separating metal solutes (e.g., transition metal solutes) out of a solution can comprise: flowing the solution through a container (e.g., a separation column) that comprises a filter; applying a magnetic field (e.g., a high-gradient magnetic field or a homogenous magnetic field) to the container while the solution flows through the container, where at least one paramagnetic solute (e.g., MnCl₂) from the solution is captured on the filter; deactivating the magnetic field; and collecting the at least one paramagnetic solute from the filter. The magnetic field is a high-gradient magnetic field. The solution can comprise at least one diamagnetic solute (e.g., ZnCl₂), and the at least one diamagnetic solute is not captured on the filter. The filter can be a metal filter, a magnetic filter (e.g., a magnetic mesh wool), and/or a stainless steel filter. The flowing of the solution through the container can comprise using a pump (e.g., a peristaltic pump) to flow the solution through the container. A final concentration of the at least one paramagnetic solute in the solution after deactivating the magnetic field can be, for example, no more than 90% (e.g., in a range of from 10%-90%, such as from 50%-90%) of an initial concentration of the at least one paramagnetic solute in the solution before applying the magnetic field to the container.

In another embodiment, a system for separating metal solutes (e.g., transition metal solutes) out of a solution can comprise: a container (e.g., a separation column) that comprises a filter and that is configured to flow the solution therethrough; an electromagnet disposed around the container and configured to apply a magnetic field (e.g., a high-gradient magnetic field or a homogenous magnetic field) to the container while the solution flows through the container, such that at least one paramagnetic solute (e.g., MnCl₂) from the solution is captured on the filter; and a pump (e.g., a peristaltic pump) connected to the container and configured to flow the solution through the container. The filter can be a metal filter, a magnetic filter (e.g., a magnetic mesh wool), and/or a stainless steel filter. The system can be configured such that no diamagnetic solute (e.g., ZnCl₂) present in the solution is captured on the filter during operation. The system can be configured such that, after operation, a final concentration of the at least one paramagnetic solute in the solution after deactivating the magnetic field can be, for example, no more than 90% (e.g., in a range of from 10%-90%, such as from 50%-90%) of an initial concentration of the at least one paramagnetic solute in the solution before applying the magnetic field to the container.

### BRIEF DESCRIPTION OF DRAWINGS

FIG. 1 shows a schematic view of an experimental setup for separation of metal solutes, according to an embodiment of the subject invention. The separation chamber can be placed inside a uniform magnetic field between the pole pieces.

FIG. 2(a) shows a plot of absorbance (in arbitrary units (a.u.)) versus concentration (in millimolar (mM)), showing the calibration curve for MnCl₂ and ZnCl₂. The solid line with the square data points is for ZnCl₂, and the dashed line with the circle data points is for MnCl₂. The slope of the lines that are best fitted to the experimental data are 11.82 and 28.88 for MnCl₂ and ZnCl₂, respectively.

FIG. 2(b) shows a plot of normalized concentration (C/C) versus time (in hours (hr)) for captured MnCl₂ metal solutes as for a broad range of initial concentrations (e.g., initial concentrations of 1 mM, 10 mM, and 100 mM). The lighter circle data points are for 1 mM; the darker circle data points are for 100 mM; and the medium circle data points are for 10 mM. The filled and open symbols correspond to a magnetic field of 1 Tesla (T) and 0 T, respectively.

FIG. 2(c) shows a plot of normalized concentration (C/C) versus time (in hr) for captured ZnCl₂ metal solutes as for a broad range of initial concentrations (e.g., initial concentrations of 1 mM, 10 mM, and 100 mM) at a magnetic field of IT. The lighter circle data points are for 1 mM; the darker circle data points are for 100 mM; and the medium circle data points are for 10 mM.

FIG. 2(d) shows a plot of normalized capture concentration (C/C) versus time (in hr) for MnCl₂ for various imposed magnetic fields and an initial concentration C₀ of 100 mM. The open (unshaded) circle data points are for 0 T; The lighter circle data points are for 0.5 T; the darker circle data points are for 1 T; and the medium circle data points are for 0.75 T.

FIG. 2(e) shows a plot of normalized recovered concentration versus flushed time (in minutes (min)) for MnCl₂ at various initial concentrations after the magnetic field was turned off from IT. The lighter circle data points are for 1 mM; the darker circle data points are for 100 mM; and the medium circle data points are for 10 mM.

FIG. 2(f) shows a plot of overall change in concentration (in percentage (%)) of metal solutes as a function of applied magnetic field (in T) after 16 hr of experiments. The lighter circle data points are for MnCl₂ at C₀=1 mM; the darker circle data points are for MnCl₂ at C₀=100 mM; the medium circle data points are for MnCl₂ at C₀=10 mM; the lighter square data points are for ZnCl₂ at C₀=1 mM; the darker square data points are for ZnCl₂ at C₀=100 mM; and the medium square data points are for ZnCl₂ at C₀=10 mM.

FIG. 3(a) shows a magnetization curve of B (in T) versus H (in T) for wire mesh.

FIG. 3(b) shows a magnetization curve of B (in T) versus H (in T) for MnCl₂ and ZnCl₂ solutes. The (blue) curve with the positive slope is for MnCl₂, and the (orange) curve with the negative slope is for ZnCl₂. The curve for MnCl₂ uses the left-hand y-axis, which shows B in Tx 103 while the curve for ZnCl₂ uses the right-hand y-axis, which shows B in T×10⁵.

FIG. 3(c) shows a plot of force ratio versus metal solute size (in nanometers (nm), showing the calculated ratio of forces from Equations 3 and 4 herein as a function of paramagnetic MnCl₂ solute size for the experimental conditions discussed herein and a magnetic field of 1 T. The (blue) curve with the larger slope is for P_{em|max}, and the (orange) curve with the smaller slope is for Ma_{m|max}. Below a critical size of Rc≈8 nm, the separation process of the metal solutes is diffusion limited (diffusion is the rate limiting factor). Beyond this critical size, the separation is limited by the viscous forces.

FIG. 4(a) shows a plot of the normalized concentration (C/C) of MnCl₂ and ZnCl₂ metal solutes as a function of time for binary mixtures containing both paramagnetic and diamagnetic solutes at a magnetic field strengths of 1 T. The open (unshaded) circle data points are for MnCl₂ at B=0 T; the dark circle data points are for MnCl₂ at B=1 T; the open (unshaded) square data points are for ZnCl₂ at B=0 T; and the dark square data points are for ZnCl₂ at B=1 T.

FIG. 4(b) shows a plot of the normalized concentration (C/C) of MnCl₂ and ZnCl₂ metal solutes as a function of time for binary mixtures containing both paramagnetic and diamagnetic solutes at a magnetic field strength of 0.5 T. The open (unshaded) circle data points are for MnCl₂ at B=0 T; the dark circle data points are for MnCl₂ at B=0.5 T; the open (unshaded) square data points are for ZnCl₂ at B=0 T; and the dark square data points are for ZnCl₂ at B=0.5 T.

FIG. 4(c) shows a plot of change in concentration (in %) versus applied magnetic field (in T) for both paramagnetic and diamagnetic metal solutes for binary mixtures. The lighter circle data points are for MnCl₂ at C₀=1 mM; the darker circle data points are for MnCl₂ at C₀=100 mM; the medium circle data points are for MnCl₂ at C₀=10 mM; the lighter square data points are for ZnCl₂ at C₀=1 mM; the darker square data points are for ZnCl₂ at C₀=100 mM; and the medium square data points are for ZnCl₂ at C₀=10 mM.

FIG. 5(a) shows a plot of normalized concentration (C/C) versus time (in hr) paramagnetic MnCl₂ at a concentration of 1 mM and an applied magnetic field of 1 T. The (blue) curve with the higher C/C values is for diffusion limit, and the (orange) curve with the lower C/C values is for flow limit.

FIG. 5(b) shows a plot of normalized concentration (C/C) versus time (in hr) paramagnetic MnCl₂ at a concentration of 10 mM and an applied magnetic field of 1 T. The (blue) curve with the higher C/C values is for diffusion limit, and the (orange) curve with the lower C/C values is for flow limit.

FIG. 5(c) shows a plot of normalized concentration (C/C) versus time (in hr) paramagnetic MnCl₂ at a concentration of 100 mM and an applied magnetic field of 1 T. The (blue) curve with the higher C/C values is for diffusion limit, and the (orange) curve with the lower C/C values is for flow limit.

FIG. 6 shows a table of model parameters used to find the best match with experimental data measured in a separation chamber.

### DETAILED DESCRIPTION

Embodiments of the subject invention provide novel and advantageous systems and methods for the transport and separation of transition metal solutes using magnetic fields. A high-gradient magnetic field (or in some cases a homogeneous magnetic field) can be generated between the flat-faced poles of an electromagnet. The magnetic separation process can be enhanced by the aggregation of paramagnetic metal solutes into clusters, which are predicted to be two orders of magnitude larger than individual solute units.

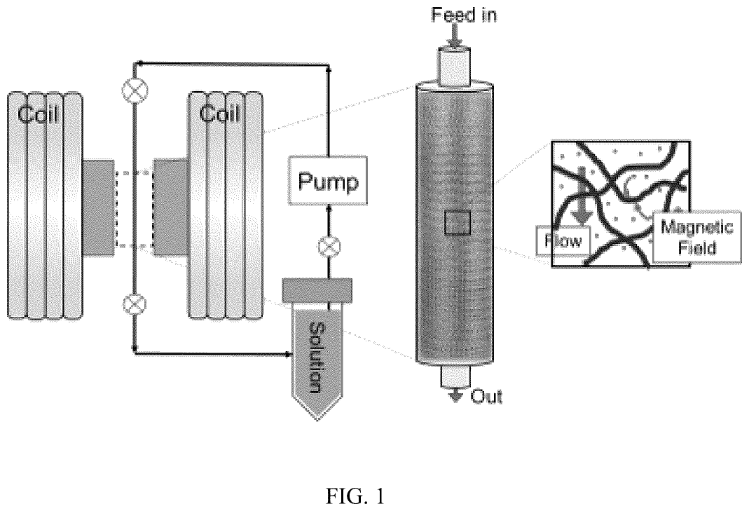

FIG. 1 shows a system for separating metal solutes (e.g., transition metal solutes) out of a solution, according to an embodiment of the subject invention. Referring to FIG. 1, the system can comprise: a container (e.g., a separation column) that comprises a filter and that is configured to flow the solution therethrough; an electromagnet disposed around the container and configured to apply a magnetic field (e.g., a high-gradient magnetic field or a homogenous magnetic field) to the container while the solution flows through the container, such that at least one paramagnetic solute (e.g., MnCl₂) from the solution is captured on the filter; and a pump (e.g., a peristaltic pump) connected to the container and configured to flow the solution through the container. The filter can be, for example, a magnetic mesh wool, such as a stainless steel wool. After operation of the system, a final concentration of the at least one paramagnetic solute in the solution can be, for example, no more than 90% (e.g., in a range of from 10%-90%, such as from 50%-90%) of an initial concentration of the at least one paramagnetic solute in the solution before operating the system.

Experiments were conducted on aqueous solutions containing either paramagnetic manganese chloride (MnCl₂) or diamagnetic zinc chloride (ZnCl₂), with concentrations ranging from 1 millimolar (mM) to 100 mM (see Examples 1 and 2). The results demonstrate that, while paramagnetic MnCl₂ is captured by mesh wool in the magnetic field, diamagnetic ZnCl₂ remains unaffected by the presence of magnetic field. The capture efficiency of paramagnetic MnCl₂ increases with both the initial solute concentration and the applied magnetic field strength. Further, in binary mixtures, the capture rate of MnCl₂ is reduced compared to single-solute solutions, highlighting the role of solute interactions in magnetic separation. The theoretical modeling indicates that magnetic capture is governed by a balance between magnetic forces and viscous forces. Additionally, the magnetic separation process can be enhanced by the aggregation of paramagnetic metal solutes into clusters, which are predicted to be two orders of magnitude larger than individual solute units. These findings provide insights into the mechanisms of magnetic separation and offer potential pathways for improving separation efficiency in complex solute mixtures that contain critical materials.

Conventional magnetic separation devices employ a low gradient magnetic field and are typically limited to separating strongly magnetic materials, such as iron and magnetite from weakly magnetic materials such as apatite [15]. Recognizing that the primary driving force behind magnetic separation is the magnetic field gradient, high-gradient magnetic field separators can be used [1,15-18]. The main component of high-gradient magnetic field separators involves the presence of a ferromagnetic matrix (in the form of a mesh of wires or grooved plates) in a uniform magnetic field [19-21]. High-gradient magnetic field separation (HGMS) has been successful in efficiently separating the micrometer-scale particles or larger aggregates [22-31].

Trajectory analysis, stochastic models, and phenomenological models have been used to model the HGMS process [32-37]. These models suffer from several simplifying assumptions. For example, these models are developed for static HGMS and do not account for time-dependent capture of particles in the system. In addition, these models do not consider the effects of build-up on the filter. As particles move through the mesh, the ability of the mesh to attract more particles decreases.

Despite significant advances in understanding the separation of fine particles (micro- and nano-sized) using high-gradient magnetic fields, a substantial gap remains in determining whether this method can effectively separate metal solutes, which are considerably smaller than the fine particles. At the scale of metal solutes (about 1 Angstrom), in the absence of inertia, diffusive forces become highly significant. Additionally, transition-metal solutes, including those found in LIBs, are either paramagnetic or diamagnetic, exhibiting weak magnetizations. Consequently, due to the small size of the solutes and their weak magnetic properties, the magnetic force driving their capture by the magnetic mesh is expected to be much weaker than the thermal diffusive forces resisting this capture. Based on this analysis, it appears unlikely that transition metal solutes with relatively weak magnetic properties can be effectively separated from solution mixtures using HGMS.

Embodiments of the subject invention provide transport and separation of transition metal salts under high-gradient magnetic fields and separation of metal solutes from mixtures. To explore this approach, two transition metal solutes were investigated: paramagnetic MnCl₂ and diamagnetic ZnCl₂. The time evolution of the concentrations of these two metal solutes in solution were evaluated with each individual metal solute and solutions that contain a binary mixture of these metal solutes. A simple model is presented to predict the evolution of solute concentration within the separation domain, providing insight into the key forces and the underlying physics that govern separation of the metal solutes in the high gradient magnetic fields.

In order to gain deeper insight into the experimental results (see also Examples 1 and 2), the separation process induced by the high-gradient magnetic field around the wire in the stainless steel mesh wool can be modeled, and key forces as play in the process can be analyzed.

In principle, the solutes that move through the HGMS may experience a range of forces including magnetic force, gravity, diffusion, viscous force, and inertia. Inertia can be assessed using the Reynolds number, which can be defined as:

$$Re = \frac{ρ \vert Uo \vert d}{η} ,$$

where ρ, U₀, d, and η are solution density, average fluid velocity imposed by the pump, wire diameter, and the solution viscosity, respectively. The Reynolds number in the experiments herein is very low (Re<<1). Therefore, inertia is negligible. In addition, because of the small size of the solutes (Rₛ≈50-70 picometers (pm)), the gravitational forces are considered negligible. On the other hand, the magnetic force that a solute with no net charge experiences can be expressed as [40-42]:

$${F}_{m} = {μ}_{0} {V}_{s} ( {M}_{s} \cdot ∇ ) H . \qquad ( 1 )$$

where μ₀ is the permeability of the free space (4π×10⁻⁷ Newtons per square Ampere (N/A²)), Fₘ is the magnetic force experienced by the solute, Vₛ is the volume of the solute, Mₛ is the magnetization of the solute, and H is the magnetic field strength created around the solute by the presence of the wire. Therefore, the magnetic field around the wire depends on the magnetization of the wire (M_{w}) and the relative distance from the surface of the wire. In addition to the magnetic force, the solute may experience thermal diffusion as a result of Brownian motion. This force could be approximated as: F_{T}˜k_{B}T/Rₛ, where k_{B}, T, and Rₛ are the Boltzmann constant, the absolute temperature, and hydrodynamic radius of the solute, respectively. Finally, in a flowing system, solutes will experience a hydrodynamic force that in the absence of inertia could be estimated as:

$${F}_{v} \approx 6 πη {U}_{0} R .$$

In a multi-collector magnetic filter, such as a steel wool separation matrix, and for a paramagnetic solute, the magnetic force is attractive towards the wire, whereas, the diffusive and viscous forces are competing against this attractive force. In order to assess the relative importance of these forces, two dimensionless numbers can be constructed. First, the ratio of magnetic force to thermal diffusion is expressed as a magnetic Peclet number:

$${Pe}_{m} = \frac{{F}_{m}}{{F}_{T}} = \frac{{μ}_{0} {V}_{s} ( {M}_{s} \cdot ∇ ) H}{{k}_{B} T / {R}_{s}} . \qquad ( 2 )$$

Note that the magnetic Peclet number varies as a function of the relative distance from the wire surface. In the vicinity of the wire, where the magnetic field gradient is at its peak, the magnetic Peclet number also reaches its maximum. The maximum magnetic field around a magnetic wire has been calculated ([30,31,43]), and this can be used to construct the maximum magnetic Peclet number as:

$${Pe}_{m} {\vert}_{max} = \begin{matrix}4 {πμ}_{o} {M}_{wire} {M}_{s} {R}_{s}^{3} \\ 3 {k}_{B} T\end{matrix} . \qquad ( 3 )$$

Here, M_{wire} is the magnetization of the wire. Second, the relative importance of the magnetic force and the viscous forces in the vicinity of the wire, can be estimated as a Mason number defined below:

$$Ma {\vert}_{max} = \frac{{F}_{m}}{{F}_{v}} {\vert}_{max} = \frac{2 {μ}_{o} {M}_{wire} {M}_{s} {R}_{s}}{9 η \vert {U}_{0} \vert} . \qquad ( 4 )$$

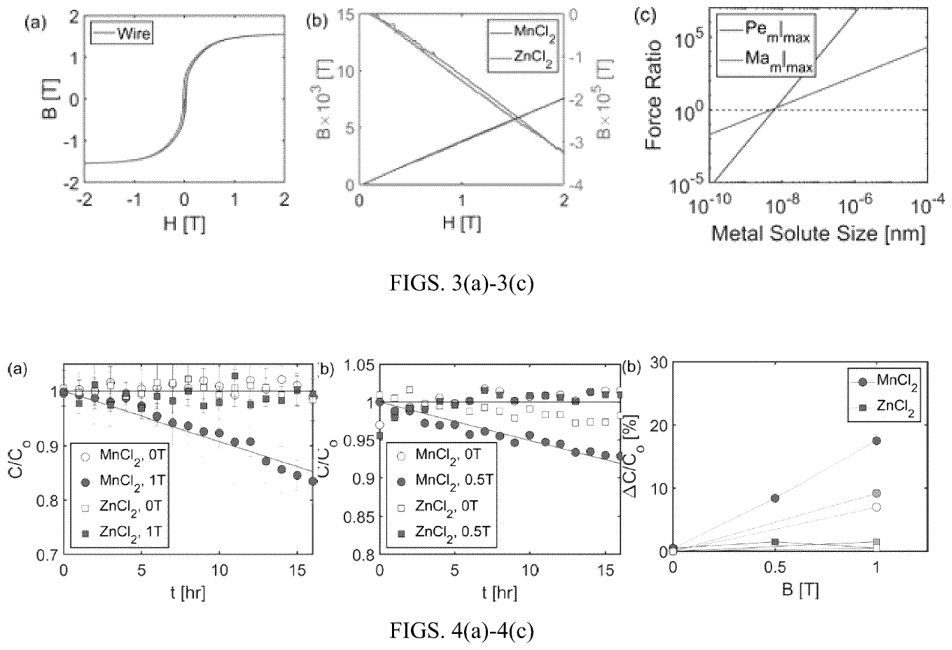

Depending on the relative importance of these forces, the diffusion or flow could be the rate limiting factor in magnetic separating and capturing the metal solutes. In order to evaluate these dimensionless parameters, need magnetization of the wire and the metal solutes would be needed. FIGS. 3(a) and 3(b) present the magnetization curves of the stainless-steel mesh wool, as well as the paramagnetic and diamagnetic samples. While the magnetization of the wire saturates for applied magnetic fields above 1 T, the metal solutes do not reach saturation within this range of magnetic fields. Using the experimentally determined magnetization of the wire, and the paramagnetic MnCl₂ solute, the ratio of these two forces has been calculated as a function of solute size for an applied magnetic field of 1 T, as shown in FIG. 3(c). The calculations indicate that below a critical solute size of approximately 8 nanometers (nm), diffusive forces dominate, while beyond this threshold, magnetic separation is limited by the viscous forces. This simple dimensionless analysis suggests that the solute size must exceed this critical threshold for any meaningful separation of the paramagnetic metal salt. Notably, this size is significantly larger than the radius of individual metal solutes, implying the possible formation of magnetically-induced solute clusters in the experiments of the Examples herein. In addition, the magnetic force for the diamagnetic ZnCl₂ is always negative, indicating that these solutes are repelled by the mesh wire. Consequently, based on this force balance, diamagnetic solutes are not expected to be captured by the mesh wool, which aligns with the experimental observations from the Examples. Following is a more detailed mass conservation model to determine the paramagnetic metal solute size required to match the experimentally observed concentration changes.

Because inertia is not important in the experiments, certain HGMS models cannot be applied to the experiments [32]. As paramagnetic metal solutes move from the top of the column to the bottom and exit the column, a portion of metal solutes is captured by the wires. In order To evaluate the capture rate of these species in this system, the mass conservation on the species as can be written as follows:

$$\frac{\partial n}{\partial t} = - ∇ \cdot ( D ∇ n ) + ∇ \cdot ( nv ) . \qquad ( 5 )$$

Here, n, D, and v are the number density of species, diffusion coefficient, and the fluid velocity, respectively. Under steady state conditions, and constant imposed fluid velocity, the mass balance along the separation column height can be written as:

$$\frac{\partial n}{\partial x} = α n . \qquad ( 6 )$$

It has been shown that α=−C/L, where C and L are the fractional capture of species in the column and the length of the column, respectively [30,31,43]. The fractional capture of species C can be given by the expression below:

$$C = \frac{{A}_{c} - b}{{ϕ}_{i} - b} \qquad ( 7 )$$

Here, A_{c}=A(1−φᵢ)/2π and φᵢ, b are the capture area of species around the wire, the initial void fraction of the column, and the buildup of species in the column, respectively. As species move through the column, they accumulate, and the rate of this buildup, impacting the capture efficiency of species by the wire, can be calculated to be:

$$\frac{\partial b}{\partial t} = - \frac{nC}{{n}_{s} L} \vert {U}_{o} \vert \qquad ( 8 )$$

Here, nₛ is the number density of species that are captured on the wire. The above model can be adopted to predict the variation of solute concentration in the experiments. The concentration of effluent after each filtration pass can be calculated by simultaneously solving Equations 6-8. The existing buildup in the column can then be used to assess the variation of solute concentration for subsequent filtration passes. The details of the equations and computational results for capture rate under diffusion and flow conditions are discussed in detail as follows.

The modeling effort involves several steps. In the first step, the radius of capture or the capture zone around a single wire are assessed for the diffusion limit and the velocity limit. The balance of the magnetic and the diffusive forces generates a capture zone around the wire with a normalized capture radius (Rₐ) of:

$${R}_{a} = {Pe}_{m} {\vert}_{max} {\frac{cos 2 θ}{2 ln ( {n}_{s} / n )}}^{1 / 2} . \qquad ( 9 )$$

Here, Rₐ=r/a, where a is the radius of the wire cross section. On the other hand, the normalized capture zone (or radius) for the velocity limit can be obtained by balancing the magnetic and viscous forces as:

$${R}_{a}^{2} / ( 2 - ln {R}_{e} - ln {R}_{a} ) = - Ma {\vert}_{max} sin θ \qquad ( 10 )$$

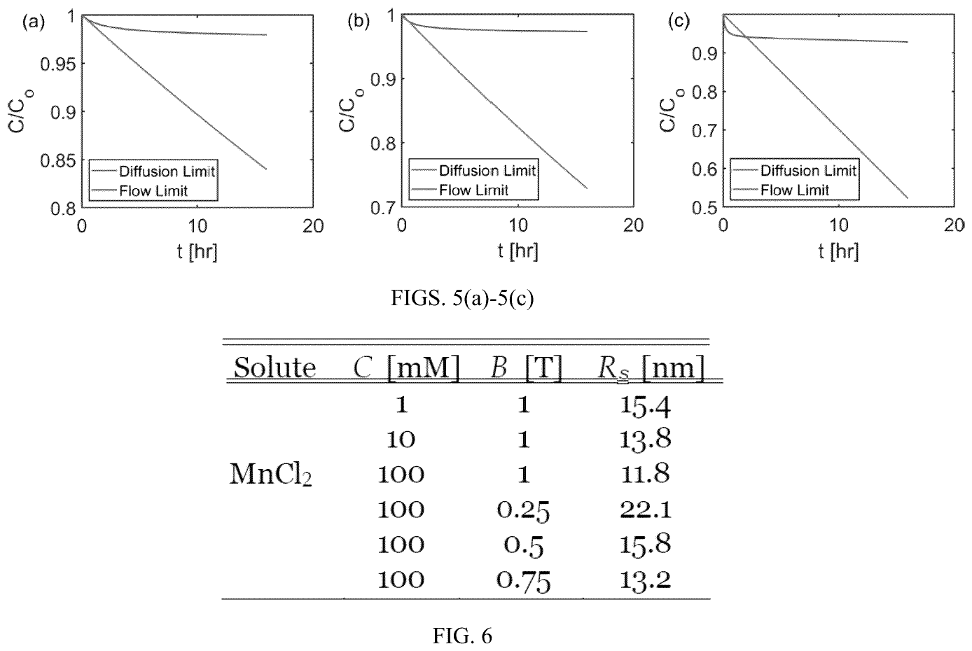

The capture area (A) is calculated on the basis of the overlap between these two capture zones. Using the capture area, Equations 6-8 can be solved to obtain the change in the number density of solutes for a single filter pass (i.e., starting from the top of the filter and exiting the solute for the first pass). After each pass, the inlet concentration of the metal solute can be considered to be the outlet concentration from the previous filtration pass. In this way, the concentration can be solved for at the end of the column after each filtration pass. Note that in the model, the number density is related to the concentration as: C=4πnRₛ³/3, and C/C₀=n/n₀. FIGS. 5(a)-5(c) show sample normalized concentration variation after 16 hours for the velocity and diffusion limit cases. It can be plainly seen that the velocity limit fits better with the experimental trend reported herein. The latter is not surprising, because the force balance analysis also indicated that for any separations to occur, the velocity (or flow) limit should be operated in.

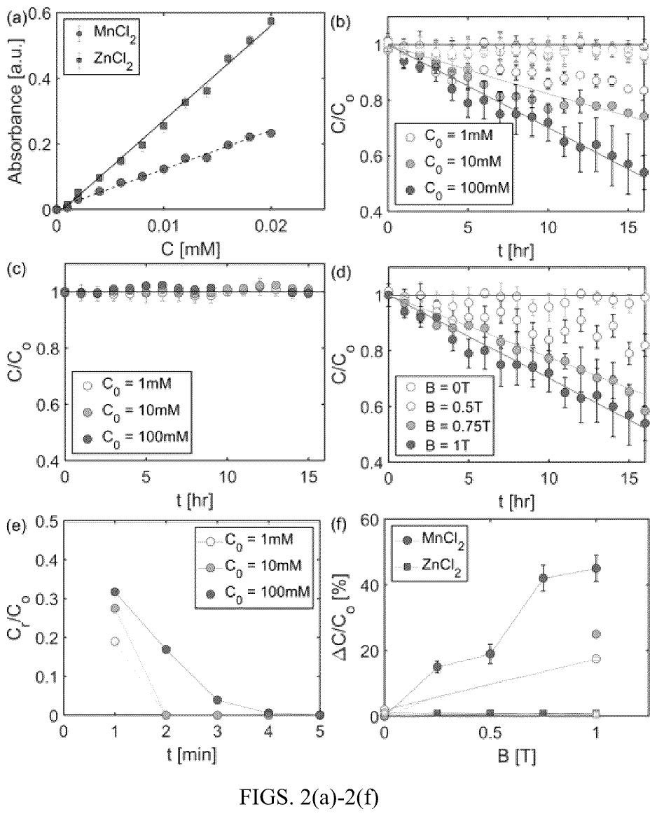

In a first attempt to calculate the concentration variation in the domain, the typical ionic radii of the metal solutes was used as a reference (e.g., 80 pm for MnCl₂ and 74 pm for ZnCl₂). Under this condition, the paramagnetic MnCl₂ shows no interaction with the magnetic field, as indicated by the normalized concentration remaining around unity, suggesting no magnetic capture (see the horizontal line in FIG. 2(b)). In order to improve the model's accuracy, the effective size of the metal solute was gradually increased to obtain the best fit with the experimental data. The continuous lines in FIG. 2(b) represent the best fit of the model to the experimental data points. Further, the model was fitted to the experimental results obtained at different magnetic field strengths, as shown in FIG. 2(d). The table in FIG. 6 provides a summary of the solute radii that yielded the best fit with the experimental data. It should be noted that the effective solute size is significantly larger, by nearly two orders of magnitude, than the hydration radius of the individual metal solute. This observation supports the premises that the paramagnetic metal solutes may have aggregated into clusters under the influence of the magnetic field, leading to their enhanced capture rate in the experiments. Transition-metal ions in porous media experience a pronounced magnetophoresis effect, much stronger than that predicted by a force balance on individual metal ions [44-46]. This discrepancy may be due to the formation of ion clusters under the influence of a non-uniform magnetic field. This aligns with the findings from the experimental and modeling efforts discussed herein. No direct experimental evidence is known to exist for formation of metal ion clusters under the influence of magnetic field.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Materials and Methods

The solutions used included transition metal salts, specifically manganese (II) chloride (MnCl₂) and zinc (II) chloride (ZnCl₂) obtained from MilliporeSigma and used as received. The solutions were prepared over a broad range of concentrations from 1 mM to 100 mM in de-ionized millipore water. Two types of solutions were made—solutions containing single metal solutes in aqueous solution and solutions containing a binary mixture of these metal solutes.

As shown in FIG. 1, the flow chamber included several parts. The separation process was conducted under the influence of a 1 Tesla electromagnet, which provided a uniform and controlled magnetic field during the experiments. The separation chamber is a single-column fabricated from borosilicate glass with a diameter and length of 1 centimeter (cm) and 10 cm, respectively. The chamber was filled with a 434-grade steel wool mesh wire with a diameter of 40 micrometers (μm) (obtained from McMaster Carr). A peristaltic pump was used to generate a continuous flow velocity of approximately 3.3 millimeters per second (mm/s), and to circulate the metal-ion solution through a closed-loop system. In order to measure the concentration of the metal solutes during experiments, the light absorbance of the metal salts in the presence of a coloring agent (Xylenone Orange) was measured via a UV-Vis spectrophotometer (3500 Agilent Technologies). Additionally, inductively coupled plasma optical emission spectroscopy (ICP-OES) was used for high-precision ion concentration analysis, particularly in experiments involving binary mixtures of metal solutes. The magnetization properties of the materials used was measured by a 16T quantum design property measurement system (PPMS) superconducting magnet with a vibrating-sample magnetometer option.

### Example 1

Experiments began by flowing solutions containing single metal solutes in deionized water through the column. In order to ensure there were no complications arising from interactions between the stainless-steel mesh wool and the aqueous solutions, control experiments were conducted in parallel, where the magnetic field was kept off. FIG. 2(a) shows the absorbance intensity for these metal solute solutions as a function of concentration. Within this concentration range, the absorbance intensity increases linearly with the concentration of the solute, indicating that the Beer-Lambert law is applicable [39]. The plot in FIG. 2(a) serves as a calibration curve to determine the concentration of metal solutes extracted from the separation chamber.

FIG. 2(b) illustrates the temporal evolution of the normalized concentration of paramagnetic MnCl₂ for different initial concentrations. The paramagnetic metal solutes were captured by the mesh wool, with the capture rate increasing over time. Further, as the initial concentration of MnCl₂ increases, the capture rate increases. It is important to note that control experiments, where the magnetic field was turned off, showed no significant change in the concentration of paramagnetic MnCl₂ solutes over time. This indicates that the observed capture is directly related to the presence of the magnetic field. FIG. 2(c) shows the temporal variation of the normalized concentration for diamagnetic ZnCl₂ solutes across a wide range of initial concentrations. The concentration remained unchanged, even after 16 hours. Unlike paramagnetic solutes, the diamagnetic ZnCl₂ solutes did not interact with the magnetic mesh wool and, therefore, were not captured by the stainless-steel mesh.

In addition, the effect of varying external magnetic field strengths on the capture rate of paramagnetic MnCl₂ was studied. FIG. 2(d) illustrates the normalized concentration of MnCl₂ as a function of time for different magnetic field intensities. As the imposed magnetic field strength increases, the overall rate of solute capture rises correspondingly. These results support the premise that the separation process is induced by the influence of the external magnetic field.

In order to further confirm this premise, the magnetic field was turned off following the experiments and subsequently the chamber was flushed with purified water. The concentration of the metal solute in the flushed fluid was measured at 1-minute time intervals. FIG. 2(e) presents the normalized concentration of recovered metal solutes as a function of time for three distinct initial concentrations, following experiments conducted at a magnetic field strength of B=1 T. The data clearly demonstrate that paramagnetic solutes can be recovered from the chamber upon deactivation of the magnetic field, thereby reinforcing the premise that the separation process is driven by the external magnetic field. Further, the results underscore the reversible nature of magnetic capture in these systems. Finally, FIG. 2(f) summarizes the capture rate of the two metal solutes after 16 hours of magnetic field exposure, plotted against the applied magnetic field across the range of initial concentrations tested in this study. The results clearly indicate that magnetic separation is enhanced with increasing magnetic field strength, with higher initial concentrations yielding greater separation efficiency for the paramagnetic MnCl₂ solutes. In contrast, the diamagnetic ZnCl₂ solutes show no interaction with the magnetic field, regardless of its strength or the initial solute concentration, and thus, their concentration remained unchanged throughout the experiments.

### Example 2

In many practical applications, metal solutes with different magnetic properties often exist in mixtures, making it crucial to develop methods that enable their effective separation from one another within the mixture. Achieving selective separation based on magnetic properties could be particularly beneficial in such contexts. Therefore, in this example, a binary solution mixture of the paramagnetic and diamagnetic metal solutes was considered, and an attempt was made to separate the solutes from each other.

FIGS. 4(a) and 4(b) show the normalized concentrations of MnCl₂ and ZnCl₂ in an equimolar mixture (100 mM) under varying magnetic fields. At a higher magnetic field strength of 1 T, MnCl₂ is effectively captured by the mesh, while the diamagnetic solutes remain largely unaffected by the presence of the magnetic field or the paramagnetic metal solutes. As a result, the diamagnetic ZnCl₂ solutes exit the column at their initial concentration. Consistent with the single component solution experiments in Example 1, increasing the magnetic field and the initial concentration of metal solutes increases the capture rate of paramagnetic MnCl₂, as shown in FIGS. 4(a)-4(c). Perhaps equally important is the observation that the capture rate of the paramagnetic metal solute in a binary mixture is reduced compared to that measured in solutions containing the binary mixture of paramagnetic and diamagnetic solutes (see, e.g., FIGS. 4(c) and 2(f)). In order to model the separation process in the binary mixture, it can be assumed that the effective magnetization of the mixture is a weighted average of the magnetization of the individual metal solutes. This can be expressed as: Mₛ=(xᵢMᵢ), where x, represents the fraction of each metal solute in the mixture, and Mᵢ denotes the magnetization of each solute. For this case, xᵢ=0.5 for each component. Using this effective magnetization for the binary mixture, the above model has been fitted to the experimental data for mixtures under different magnetic field strengths. The resulting predictions are shown as continuous curves in FIGS. 4(a) and 4(b). The critical radii values that produce the best match with mixture experiments turn out to be larger than those noted in the table in FIG. 6 (Rₛ≈20.3 nanometers (nm) and 15 nm for B=1 T and B=0.5 T, respectively). These results underscore the impact of magnetic field strength on solute capture and highlight the complexity of separating metal solutes in mixtures.

The examples show the first experimental demonstration of separating paramagnetic and diamagnetic metal solutes, specifically MnCl₂ and ZnCl₂, from a solution mixture using high-gradient magnetic fields generated by a stainless steel mesh. This highlights the potential for the use of magnetic fields to selectively capture metal ions on the basis of their magnetic properties. The experiments were conducted on solutions containing either individual metal solutes or binary aqueous mixtures. For solutions with single metal solutes, the paramagnetic MnCl₂ was effectively attracted to the magnetic mesh wool, whereas the diamagnetic ZnCl₂ remained unaffected by the magnetic field gradients. It was observed that increasing the initial concentration of the paramagnetic metal solute and the external magnetic field strength enhanced the rate of magnetic capture.

In binary mixtures, paramagnetic metal solutes were similarly captured by the magnetic mesh wool, with the capture rate increasing as both the magnetic field strength and the initial solute concentration are raised. However, the capture rate of paramagnetic solutes in binary mixtures was lower than that observed in solutions containing only single metal salts. The presence of the diamagnetic solute in the mixture may reduce the overall magnetization of the paramagnetic solution. This reduction in magnetization may lead to a decreased attraction to the magnetic mesh wires, resulting in a lower capture rate for the paramagnetic solute.

Further, the magnetic separation of these metal salts was modeled using a framework designed to capture micro/nano particles in high-gradient magnetic separators, which incorporate magnetic, viscous, and diffusive forces. The modeling indicates that to achieve the observed levels of magnetic capture (10%-50% depending on the conditions), the paramagnetic metal solutes must aggregate into clusters significantly larger than their individual units under the influence of magnetic fields (for example, ≈10 nm). This finding aligns with observations of magneto-migration in porous media, where magnetic-induced cluster formation may lead to significant magnetomigration velocities [44-47].

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section, if present) are incorporated by reference in their entirety, including all figures and tables, to the extent they are not inconsistent with the explicit teachings of this specification.

### REFERENCES

¹Charles Godfrey Gunther. Electro-magnetic ore separation. Hill Publishing Company, 1909.
²Petra Dames, Bernhard Gleich, Andreas Flemmer, Kerstin Hajek, Nicole Seidl, Frank Wiekhorst, Dietmar Eberbeck, Iris Bittmann, Christian Bergemann, Thomas Weyh, et al. Targeted delivery of magnetic aerosol droplets to the lung. Nature nanotechnology, 2(8):495-499, 2007.
³Ulrich E Steiner and Thomas Ulrich. Magnetic field effects in chemical kinetics and related phenomena. Chemical Reviews, 89(1):51-147, 1989.
⁴Cafer T Yavuz, J T Mayo, William W Yu, Arjun Prakash, Joshua C Falkner, Sujin Yean, Lili Cong, Heather J Shipley, Amy Kan, Mason Tomson, et al. Low-field magnetic separation of monodisperse fe3o4 nanocrystals. science, 314(5801):964-967, 2006.
⁵JitKang Lim, Swee Pin Yeap, and Siew Chun Low. Challenges associated to magnetic separation of nanomaterials at low field gradient. Separation and Purification Technology, 123:171-174, 2014.
⁶J T Kemsheadl and J Ugelstad. Magnetic separation techniques: their application to medicine. Molecular and cellular Biochemistry, 67:11-18, 1985.
⁷Akira Ito, Masashige Shinkai, Hiroyuki Honda, and Takeshi Kobayashi. Medical application of functionalized magnetic nanoparticles. Journal of bioscience and bioengineering, 100(1):1-11, 2005.
⁸Arda I, sildar, Eric D van Hullebusch, Markus Lenz, Gijs Du Laing, Alessandra Marra, Alessandra Cesaro, Sandeep Panda, Ata Akcil, Mehmet Ali Kucuker, and Kerstin Kuchta.
Biotechnological strategies for the recovery of valuable and critical raw materials from waste electrical and electronic equipment (weee)—a review. Journal of hazardous materials, 362:467-481, 2019.
⁹Ka Ho Chan, John Anawati, Monu Malik, and Gisele Azimi. Closed-loop recycling of lithium, cobalt, nickel, and manganese from waste lithium-ion batteries of electric vehicles. ACS Sustainable Chemistry & Engineering, 9(12):4398-4410, 2021.
¹⁰Ka Ho Chan, Monu Malik, and Gisele Azimi. Separation of lithium, nickel, manganese, and cobalt from waste lithium-ion batteries using electrodialysis. Resources, Conservation and Recycling, 178:106076, 2022.
¹¹Jincan He, Meiying Huang, Dongmei Wang, Zhuomin Zhang, and Gongke Li. Magnetic separation techniques in sample preparation for biological analysis: a review. Journal of pharmaceutical and biomedical analysis, 101:84-101, 2014.
¹²Giacomo Mariani, Massimo Fabbri, Francesco Negrini, and Pier Luigi Ribani. High-gradient magnetic separation of pollutant from wastewaters using permanent magnets. Separation and Purification Technology, 72(2):147-155, 2010.
¹³C Sierra, J Mart′inez, Juan Mar′ia Menéndez-Aguado, E Afif, and JR Gallego. High intensity magnetic separation for the clean-up of a site polluted by lead metallurgy. Journal of hazardous materials, 248:194-201, 2013.
¹⁴Yufei Qin, Zichun Yao, Jujun Ruan, and Zhenming Xu. Motion behavior model and multistage magnetic separation method for the removal of impurities from recycled waste plastics. ACS Sustainable Chemistry & Engineering, 9(32):10920-10928, 2021.
¹⁵M Iranmanesh and J Hulliger. Magnetic separation: its application in mining, waste purification, medicine, biochemistry and chemistry. Chemical Society Reviews, 46(19):5925-5934, 2017.
¹⁶S Sugden. Magnetochemistry. Journal of the Chemical Society (Resumed), pages 328-333, 1943.
¹⁷J Oberteuffer. High gradient magnetic separation. IEEE Transactions on Magnetics, 9(3):303-306, 1973.
¹⁸Henry Kolm, John Oberteuffer, and David Kelland. High-gradient magnetic separation. Scientific American, 233(5):46-55, 1975.
¹⁹D. H. Katz and J. P. McCarthy. Materials for high gradient magnetic separation. Journal of Magnetism and Magnetic Materials, 37(3):301-308, 1984.
²⁰Y. Mori, K. Noguchi, and K. Inoue. Development of high gradient magnetic separation. IEEE Transactions on Magnetics, 28(4):2344-2346, 1992.
²¹F. E. Gerber. Advances in high gradient magnetic separation. Minerals Engineering, 8(5):575-583, 1995.
²²FEBJ Luborsky and B Drummond. High gradient magnetic separation: Theory versus experiment. IEEE Transactions on Magnetics, 11(6):1696-1700, 1975.
²³Zixing Xue, Yuhua Wang, Xiayu Zheng, Dongfang Lu, Zihang Jing, Xudong Li, Zhicheng Hu, and Yanhong Wang. Role of gravitational force on mechanical entrainment of nonmagnetic particles in high gradient magnetic separation. Minerals Engineering, 186:107726, 2022.
²⁴J H P Watson and Zhengnan Li. Theoretical and single-wire studies of vortex magnetic separation. Minerals Engineering, 5(10-12):1147-1165, 1992.
²⁵Zixing Xue, Yuhua Wang, Xiayu Zheng, Dongfang Lu, and Xudong Li. Particle capture of special cross-section matrices in axial high gradient magnetic separation: A 3d simulation. Separation and Purification Technology, 237:116375, 2020.
²⁶Luzheng Chen, Jianwu Zeng, Changping Guan, Huifen Zhang, and Ruoyu Yang. High gradient magnetic separation in centrifugal field. Minerals Engineering, 78:122-127, 2015.
²⁷Xiayu Zheng, Yuhua Wang, Dongfang Lu, and Xudong Li. Theoretical and experimental study on elliptic matrices in the transversal high gradient magnetic separation. Minerals Engineering, 111:68-78, 2017.
²⁸Jianwu Zeng, Xiong Tong, Fan Yi, and Luzheng Chen. Selective capture of magnetic wires to particles in high gradient magnetic separation. Minerals, 9(9):509, 2019.
²⁹Fangping Ye, Hongquan Deng, Zhiqiang Guo, Bing Wei, and Xiangjun Ren. Separation mechanism and experimental investigation of pulsating high gradient magnetic separation. Results in Physics, 49:106482, 2023.
³⁰Andre Ditsch, Simon Lindenmann, Paul E Laibinis, Daniel I C Wang, and T Alan Hatton. High-gradient magnetic separation of magnetic nanoclusters. Industrial & Engineering Chemistry Research, 44(17):6824-6836, 2005.
³¹Geoffrey D Moeser, Kaitlin A Roach, William H Green, T Alan Hatton, and Paul E Laibinis. High-gradient magnetic separation of coated magnetic nanoparticles. AIChE Journal, 50(11):2835-2848, 2004.
³²J HP Watson. Magnetic filtration. Journal of Applied Physics, 44(9):4209-4213, 1973.
³³J Watson. Theory of capture of particles in magnetic high-intensity filters. IEEE Transactions on Magnetics, 11(5):1597-1599, 1975.
³⁴J Svoboda. A realistic description of the process of high-gradient magnetic separation. Minerals Engineering, 14(11):1493-1503, 2001
³⁵AV Sandulyak. Magnetic filtration of liquids and gases. Ximiya, Moscow, pages 40-80, 1988.
³⁶Teymuraz Abbasov, Muhammet Koksal, and Saadetdin Herdem. Theory of high-gradient magnetic filter performance. IEEE transactions on magnetics, 35(4):2128-2132, 1999.
³⁷Teymuraz Abbasov and Ayse Sarimeseli Altunbas. Determination of the particle capture radius in magnetic filters with velocity distribution profile in pores. Separation science and technology, 37(9):2037-2053, 2002.
³⁸Sigurds Arajs, Curt A Moyer, R Aidun, and E Matijevic′. Magnetic filtration of submicroscopic particles through a packed bed of spheres. Journal of Applied Physics, 57(8):4286-4288, 1985.
³⁹Donald F Swinehart. The beer-lambert law. Journal of chemical education, 39(7):333, 1962.
⁴⁰Martin D Simon and Andre K Geim. Diamagnetic levitation: Flying frogs and floating magnets. Journal of applied physics, 87(9):6200-6204, 2000.
⁴¹Rollin J Parker. Advances in permanent magnetism. (No Title), 1990.
⁴²Peter Rassolov, Jamel Ali, Theo Siegrist, Munir Humayun, and Hadi Mohammadigoushki. Magnetophoresis of paramagnetic metal ions in porous media. Soft Matter, 20(11):2496-2508, 2024.
⁴³Derrik Fletcher. Fine particle high gradient magnetic entrapment. IEEE Transactions on Magnetics, 27(4):3655-3677, 1991.
⁴⁴M Fujiwara, K Chie, J Sawai, D Shimizu, and Y Tanimoto. On the movement of param-agnetic ions in an inhomogeneous magnetic field. The Journal of Physical Chemistry B, 108(11):3531-3534, 2004.
⁴⁵M Fujiwara, K Mitsuda, and Y Tanimoto. Movement and diffusion of paramagnetic ions in a magnetic field. The journal of physical chemistry B, 110(28):13965-13969, 2006.
⁴⁶Agnieszka Franczak, Koen Binnemans, and Jan Fransaer. Magnetomigration of rare-earth ions in inhomogeneous magnetic fields. Physical Chemistry Chemical Physics, 18(39):27342-27350, 2016.
⁴⁷M Fujiwara, D Kodoi, W Duan, and Y Tanimoto. Separation of transition metal ions in an inhomogeneous magnetic field. The Journal of Physical Chemistry B, 105(17):3343-3345, 2001.

What is claimed is:

1. A method for separating metal solutes out of a solution, the method comprising:
flowing the solution through a container that comprises a filter;
applying a magnetic field to the container while the solution flows through the container, wherein at least one paramagnetic solute from the solution is captured on the filter;
deactivating the magnetic field; and
collecting the at least one paramagnetic solute from the filter.

2. The method according to claim 1, wherein the magnetic field is a high-gradient magnetic field.

3. The method according to claim 1, wherein the container is a separation column.

4. The method according to claim 1, wherein the solution comprises at least one diamagnetic solute.

5. The method according to claim 4, wherein the at least one diamagnetic solute is not captured on the filter.

6. The method according to claim 1, wherein the filter is a metal filter.

7. The method according to claim 1, wherein the filter is a magnetic mesh wool.

8. The method according to claim 1, wherein the filter is a stainless steel filter.

9. The method according to claim 1, wherein the flowing of the solution through the container comprises using a pump to flow the solution through the container.

10. The method according to claim 9, wherein the pump is a peristaltic pump.

11. The method according to claim 1, wherein a final concentration of the at least one paramagnetic solute in the solution after deactivating the magnetic field is no more than 90% of an initial concentration of the at least one paramagnetic solute in the solution before applying the magnetic field to the container.

12. The method according to claim 1, wherein a final concentration of the at least one paramagnetic solute in the solution after deactivating the magnetic field is in a range of from 50% to 90% of an initial concentration of the at least one paramagnetic solute in the solution before applying the magnetic field to the container.

13. A system for separating metal solutes out of a solution, the system comprising:
a container that comprises a filter and that is configured to flow the solution therethrough;
an electromagnet disposed around the container and configured to apply a magnetic field to the container while the solution flows through the container, such that at least one paramagnetic solute from the solution is captured on the filter; and
a pump connected to the container and configured to flow the solution through the container.

14. The system according to claim 13, wherein the magnetic field is a high-gradient magnetic field.

15. The system according to claim 13, wherein the container is a separation column.

16. The system according to claim 13, wherein the filter is a metal filter.

17. The system according to claim 13, wherein the filter is a magnetic mesh wool.

18. The system according to claim 13, wherein the filter is a stainless steel filter.

19. The system according to claim 13, wherein the pump is a peristaltic pump.

20. The system according to claim 13, wherein the system is configured such that, after operation, a final concentration of the at least one paramagnetic solute in the solution after deactivating the magnetic field is in a range of from 50% to 90% of an initial concentration of the at least one paramagnetic solute in the solution before applying the magnetic field to the container.
